(19) United States
(12) Patent Application Publication
(10) Pub. No.: US 2013/0189114 A1
(43) Pub. Date: Jul. 25, 2013

(54) METHOD OF MANUFACTURING A WIND TURBINE BLADE AND A WIND TURBINE BLADE

(71) Applicants: Dominique Jenzewski, Berlin (DE); Andreas Cremer, Greater London (GB)

(72) Inventors: Dominique Jenzewski, Berlin (DE); Andreas Cremer, Greater London (GB)

(73) Assignees: EUROS ENTWICKLUNGSGESELLSCHAFT FUR WINDKRAFTAN- LAGEN MBH, Berlin (DE); MITSUBISHI HEAVY INDUSTRIES, LTD., Tokyo (JP)

(21) Appl. No.: 13/390,829

(22) PCT Filed: Dec. 9, 2011
(86) PCT No.: PCT/JP11/06904

§ 371 Date: Mar. 15, 2013

(51) Int. Cl. B21K 3/04; F03D 1/06

(52) U.S. Cl. CPC B21K 3/04; F03D 1/0675
USPC 416/229 R; 29/889.7

(57) ABSTRACT

The invention relates to a method for manufacturing a wind turbine blade, comprising the steps of pre-manufacturing a first blade member, positioning said pre-manufactured first blade member in a joining mold and bonding said first blade member with a second blade member using a vacuum assisted infusion process so as to form an integrated blade part.

### TECHNICAL FIELD

The invention relates to a method of manufacturing a wind turbine blade. In a further aspect, the invention relates to a wind turbine blade produced by using a certain production method.

### BACKGROUND ART

Since the trend in wind turbine development has evolved towards an enlarged size of wind turbines, also the size of the wind turbine blades has increased to a large extent, especially concerning the blades of offshore wind turbines. As a consequence of this development, manufacturing wind turbine blades is an extremely difficult task whose importance has risen significantly during the recent years.

Due to their enormous size, wind turbine blades are not manufactured in one piece. Usually, two blade half shells are manufactured separately and subsequently bonded. It is also common to produce each blade half shell in several production steps out of several blade half shell parts. These parts are bonded in a joining mold to form an entire blade half shell. For bonding the different blade half shell parts, usually adhesives such as gluing paste are used. A disadvantage of applying adhesives is the fact that its distribution and bonding strength can hardly be controlled, resulting in a varying quality of the connection.

US 2009/0155084 A1 discloses a manufacturing method for a wind turbine blade which tries to overcome the above mentioned problem. The described method includes the assembly of a plurality of wind turbine blade segments in the longitudinal direction of the blade. Bonding the different wind turbine blade segments using an adhesive is done by providing a bonding grid which enhances the distribution of the adhesive. A disadvantage of this solution is the arrangement of the blade into several segments in the longitudinal direction as this restricts the use of strengthening elements extending in the longitudinal direction of the blade such as spar caps. Another disadvantage is that the above method is very cumbersome and therefore does not decrease the effort related to bonding blade segments by adhesives.

Another major disadvantage which also increases the effort of manufacturing a wind turbine blade is the restricted access to the joining mold, therefore resulting in difficulties in placing blade building material or blade parts to be bonded in the joining mold.

### SUMMARY OF INVENTION

It is the object of the invention to provide an improved manufacturing method for wind turbine blades. It is a further object of the present invention to provide a wind turbine blade which is produced by the enhanced manufacturing method.

According to the present invention, the method of manufacturing a wind turbine blade comprises the steps of pre-manufacturing a first blade member in a mold. The pre-manufactured first blade member is placed in a joining mold and bonded to a second blade member using a vacuum assisted infusion process to form an integrated part of the blade. The joining mold can either be the same mold in which the first blade member was pre-manufactured or a different mold.

The pre-manufactured first blade member preferably comprises a spar cap. A spar cap is the main structural member of the blade carrying its weight and the loads acting on it. The spar cap comprises composite material whose fibers run in the longitudinal direction of the blade and the spar cap extends along substantially the entire length of the blade. In a further embodiment of the invention, the pre-manufactured first blade member comprises two spar caps which are connected by a strong shell structure. The shell structure can also comprise composite material, preferably a monolithic structure or a sandwich type structure.

Pre-manufacturing the first blade member can be done in one step by use of an infusion process or in several steps including pre-manufacturing the spar caps by infusion and connecting the spar caps and the shell structure by direct roving.

The bonding between the first and the second blade member is done using a vacuum assisted infusion process. The term “infusion process” relates to any bonding process including the step of infusing a bonding means for bonding. The term “vacuum assisted” means that a vacuum is applied to the area in which the bonding means is infused. Preferably, the vacuum is applied using a foil as a vacuum bag which is laid over the area to be infused allowing the creation of a vacuum. Once a vacuum is established, it ensures a uniform and controllable flow of the bonding means. Consequently, a good bonding quality can be achieved.

In a further embodiment of the invention, the method comprises the steps of curing the pre-manufactured first blade member, demolding it and transporting it to the joining mold in which it is bonded to a second blade member to form an integrated part of the blade member. Preferably, the integrated part of the blade is cured and bonded to other blade members, again using a vacuum assisted infusion process. These steps are repeated, until a half shell of the blade or the entire blade is completed. In this context, curing can refer to pre-curing, after which a certain extent of rigidity has been achieved but the full strength has not been established yet, or post-curing, after which the full strength of the member has developed.

In a further embodiment of the invention, the pre-manufactured first blade member comprises at least one spar cap. Preferably, the pre-manufactured first blade member is positioned in the center of the joining mold which is usually very hard to access by workers. Further preferably, the pre-manufactured first blade member extends along substantially the entire length of the blade to be manufactured. Positioning an already pre-manufactured blade member in the central area of the joining mold eliminates the need for workers to walk inside the mold or to use cranes in order to access this central area. This simplifies the blade construction enormously since the usually very restricted access to the central areas of the joining mold is overcome.

Furthermore, the pre-manufactured first blade member, being positioned in the center of the joining mold and extending along its longitudinal direction, is sufficiently strong to be used for transporting and placing the second blade member in the joining mold. The pre-manufactured first blade member, in particular the spar cap, is adapted to be walked on by workers building the blade in order to position the second blade member in the joining mold.

Preferably, the pre-manufactured first blade member comprises an integrated bonding flange for the connection to other blade members. In an alternative embodiment, the second blade member comprises at least one bonding flange for the connection to the pre-manufactured first blade member. In particular, the first blade member can comprise one bonding flange on each of its longitudinal sides, the trailing edge side and the leading edge side, respectively. Preferably, the bonding flanges extend along the whole length of the leading edge side and trailing edge side of the first blade member. In another preferred embodiment, the end faces of the pre-manufactured first blade member also comprise bonding flanges. In a particular preferred embodiment, the bonding flange comprises a peel ply as a thin protective layer which is removed before the infusion process in order to ensure a good surface quality for the connection to another blade member.

In a further embodiment of the invention, the second blade member comprises blade building material which is positioned in the joining mold overlapping the first blade member, in particular its bonding flange. A vacuum is applied to the blade building material which is infused by bonding means, therefore infiltrating the blade building material with the bonding means. The second blade member is therefore formed during the bonding process to the first blade member. Preferably, bonding means comprise epoxy resin. The blade building material can be any “dry” material, meaning material which has not been infiltrated with bonding means before. The blade building material can, for example, comprise fibers, balsa, woven or stitched fabrics or sandwich cores. In a further embodiment, heat is applied to the integrated part for curing the bonding means. This can be achieved by use of an integrated heating system.

In a preferred embodiment, a complete half shell of the blade is manufactured by applying the above method to each one of the bonding flanges on the trailing edge side and the leading edge side of the pre-manufactured first blade member, respectively. This is done by filling the joining mold along its transverse direction and bonding the blade material to the pre-manufactured first blade member until an entire blade half shell is produced.

In an alternative embodiment, the second blade member is also pre-manufactured. The pre-manufactured second blade member is placed next to the pre-manufactured first blade member in such a way that an interspace, a bonding gap, between the two blade members exists. The second blade member can be placed next to the pre-manufactured first blade member in cross direction or in longitudinal direction of the blade to be manufactured. The second blade member can also be positioned on top of the pre-manufactured first blade member. A vacuum is applied to the bonding gap, preferably by using a vacuum bag such as a plastic foil which enables an air tight seal so that a vacuum can be applied. Subsequently, the bonding gap is infused with bonding means, preferably epoxy resin, which after curing will establish the connection. Compared to using gluing paste, the use of epoxy resin in combination with a vacuum assisted infusion process is advantageous as it allows a better control of bonding gap thickness and bonding quality. Preferably, a flow medium is inserted in the bonding gap for allowing an even more improved flow of the bonding means. The flow medium can be a distribution means and is preferably structured, such as e.g. a mat, which provides passageways for the bonding means for a continuous and controllable flow. In another preferable embodiment, the bonding gap is filled with some suitable sort of “dry” material, in particular comprising fabric or textile material, which will act as a flow medium for the bonding means. In a further embodiment, heat is applied to the integrated part for curing the bonding means, preferably by means of an integrated heating system.

In a preferred embodiment, the above process is repeated until a half shell of a blade or an entire blade is manufactured. Preferably, the above method comprises the steps of curing the second pre-manufactured blade member, demolding it and transporting it to the joining mold. These steps can be repeated, until all remanufactured blade members are completed.

In another preferred embodiment, the blade comprises a middle portion, a tip portion and a root portion. The pre-manufactured first blade member is bonded with at least one other blade member using a vacuum assisted infusion process in order to form an integrated part of the middle portion, the tip portion and the root portion of the blade, respectively. The integrated parts of the middle portion, tip portion and the root portion of the blade are consecutively bonded, preferably by a vacuum assisted infusion process, to form an entire blade or an entire blade half shell.

In another aspect of the invention, the blade comprises a suction side and a pressure side in the transverse direction. The method of manufacturing a wind turbine blade comprises pre-manufacturing at least one spar cap, at least one shear web, at least one trailing edge part and at least one leading edge part, preferably in multiple pre molds. The pre-manufactured parts are bonded using a vacuum assisted infusion process for forming an entire blade or an entire blade half shell of the suction side and the pressure side respectively. This bonding process can also include other blade parts. Especially, the spar cap can be bonded to another spar cap via a strong shell structure, whereas this other blade part can comprise bonding flanges. Optionally, the corresponding blade half shells are consecutively bonded in order to form an entire blade.

In a preferred embodiment, two spar caps and two shear webs are produced as well as one leading edge part and one trailing edge part. The pre-manufactured parts are placed in a joining mold and bonded by means of a vacuum assisted infusion process for forming an entire blade half shell. In an alternative embodiment of the invention, the leading edge part and the trailing edge part are both adapted to have one section which forms a part of the suction side of the blade and another section which forms a part of the pressure side of the blade. Therefore, after bonding the leading edge part and the trailing edge part with at least two pre-manufactured spar caps and preferably two pre-manufactured shear webs an entire blade is produced.

In a further preferred embodiment, multiple leading edge parts and multiple trailing edge parts in longitudinal direction of the blade to be manufactured are pre-manufactured. These multiple leading edge parts and multiple trailing edge parts are bonded by means of a vacuum assisted infusion process to each other or to other pre-manufactured parts for forming an entire blade half shell or an entire blade.

In another preferred embodiment of the invention, one or more pre-manufactured parts are bonded with a root reinforcement part in the joining mold using a vacuum assisted infusion process in order to form the root portion of the blade or the root portion of a blade half shell. The root portion refers to the part of the blade or the blade half shell which is located at its root end.

In a preferred embodiment, outer root layers are placed on the surface of the root portion of the entire manufactured blade and bonded to the root portion using a vacuum assisted infusion process to form an outer root reinforcement part. Alternatively, fabric winding can be used for winding outer root layers around the root portion of the blade and therefore building up an outer root reinforcement part.

In another aspect of the invention, a wind turbine blade manufactured by using a method comprising the following steps is provided: First, a first blade member is pre-manufactured in a mold and positioned in a joining mold. The joining mold can be the same mold in which the first blade member was pre-manufactured or a different mold. Preferably, the pre-manufactured first blade member is positioned in the center of the joining mold. Subsequently, said first blade member is bonded with a second blade member using a vacuum assisted infusion process for forming an integrated part of the blade which is in turn bonded with other blade members again using a vacuum assisted infusion process. This process is repeated until an entire blade or an entire blade half shell of the suction side and the pressure side is completed respectively. Optionally, said blade half shells are consecutively bonded in order to form an entire blade.

### BRIEF DESCRIPTION OF DRAWINGS

The invention will be described below with reference to the following figures which show in schematic representation

FIG. 1 is a cross sectional view of a pre-manufactured first blade member in a joining mold;

FIG. 2 is a cross sectional view of the pre-manufactured first blade member of FIG. 1 and blade building material;

FIG. 3 is a cross sectional view of a pre-manufactured first blade member and a second blade member in a joining mold in the area of the middle portion of a blade;

FIG. 4 is a cross sectional view of the pre-manufactured first blade member of FIG. 3 and an inner root reinforcement part in the area of the root portion of the blade;

FIG. 5 is a cross sectional view of two corresponding blade half shells in the area of the middle portion of a blade;

FIG. 6 is a cross sectional view of the two corresponding blade half shells of FIG. 5 in the area of the root portion of the blade; and

FIG. 7 is a cross sectional view of the root portion of the blade of FIG. 6 with an outer root reinforcement part.

### DESCRIPTION OF EMBODIMENTS

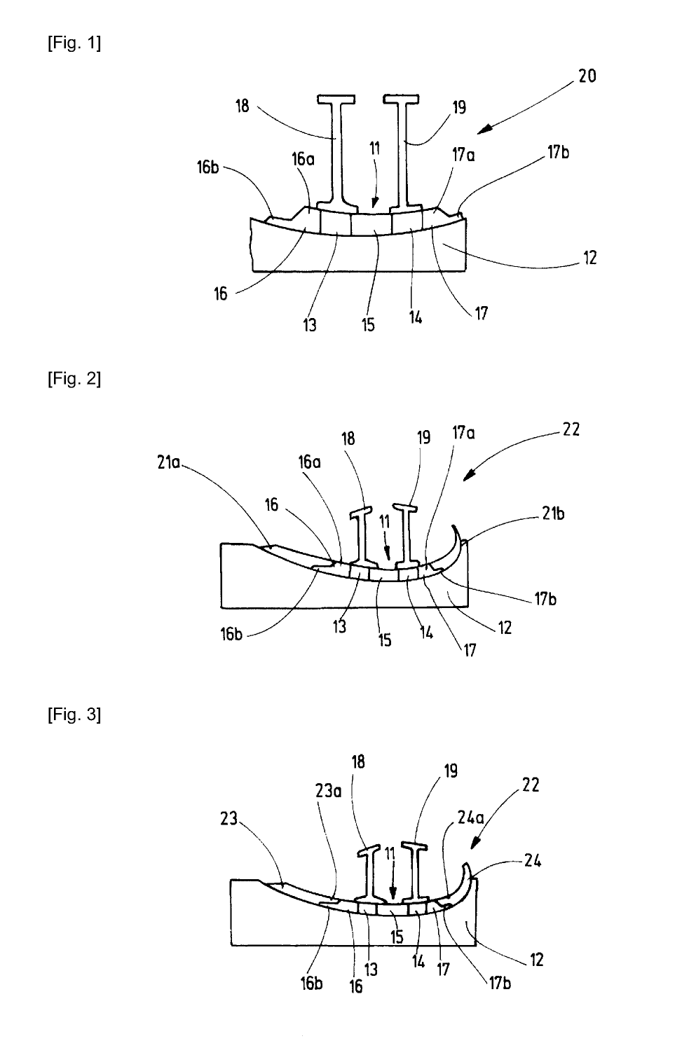

FIG. 1 shows a cross sectional view of a pre-manufactured first blade member 11 and of a section of a joining mold 12. The joining mold 12 comprises a shaped cavity which is utilized to give an intended form to a blade member or blade half shell to be manufactured. The pre-manufactured first blade member 11 comprises two spar caps 13, 14 which are connected to each other via a sandwich structure 15 consisting of a light weighted core surrounded by fiber reinforced material. Furthermore, the pre-manufactured first blade member 11 comprises two bonding flanges, namely one bonding flange 16 at the trailing edge side and one bonding flange 17 at the leading edge side of the pre-manufactured first blade member 11. The bonding flanges 16, 17 extend continuously along the longitudinal direction of the pre-manufactured first blade member 11. The bonding flanges 16, 17 comprise a first part 16a, 17a which is arranged adjoining the joining mold 12 and one spar cap 13, 14, respectively. Furthermore, the bonding flanges 16, 17 comprise a second part 16b, 17b which is formed integrally with the first part 16a, 17a. The second parts 16b, 17b are formed as a flat extension adjoining the joining mold 12. The bonding flanges 16, 17 together amount to about 30 to 50 percent of the width of the pre-manufactured first blade member 11 in cross direction. After positioning the pre-manufactured first blade member, it is bonded with two shear webs 18, 19 which form second blade members using a vacuum assisted infusion process so that an integrated blade part 20 is formed. For this purpose, one shear web 18, 19 is positioned on the inner side of one spar cap 13, 14 of the pre-manufactured first blade member 11, respectively.

In FIG. 2 a cross sectional view of the pre-manufactured first blade member 11 of FIG. 1 in the joining mold 12 is shown in which blade building material 21a, 21b is placed next to the pre-manufactured first blade member 11 on each of its longitudinal sides respectively. The blade building material 21a, 21b is positioned along the longitudinal sides of the pre-manufactured first blade member 11 in such a way that it overlaps with the second parts 16b, 17b of the bonding flanges 16, 17 of the pre-manufactured first blade member 11. The pre-manufactured first blade member 11 and the blade building material 21a, 21b are bonded using a vacuum assisted infusion process respectively by applying a vacuum to the blade building material 21a, 21b and infusing it with bonding means. As a result, two other blade members are formed during the two bonding processes. By means of the bonding processes, an entire blade half shell 22 is produced.

FIG. 3 shows a cross sectional view of a pre-manufactured first blade member 11 comprising two spar caps 13, 14 in a joining mold 12 in the area of the middle portion of the blade half shell to be manufactured. The pre-manufactured first blade member 11 comprises a bonding flange 16 at the trailing edge side and a bonding flange 17 at its leading edge side. Next to the bonding flange 16 at the trailing edge side a pre-manufactured trailing edge part 23 is placed which comprises a mating flange 23a which corresponds to the bonding flange 16 of the pre-manufactured first blade member 11.

The pre-manufactured trailing edge part 23 is bonded to the pre-manufactured first blade member 11 using a vacuum assisted infusion process. At the bonding flange 17 at the leading edge side of the pre-manufactured first blade member 11 a pre-manufactured leading edge part 24 is positioned which also comprises a mating flange 24a corresponding to the bonding flange 17 of the pre-manufactured first blade member 11. The pre-manufactured leading edge part 24 is bonded to the pre-manufactured first blade member 11 by the use of a vacuum assisted infusion process. After the bonding processes, an entire half shell 22 of a blade is produced.

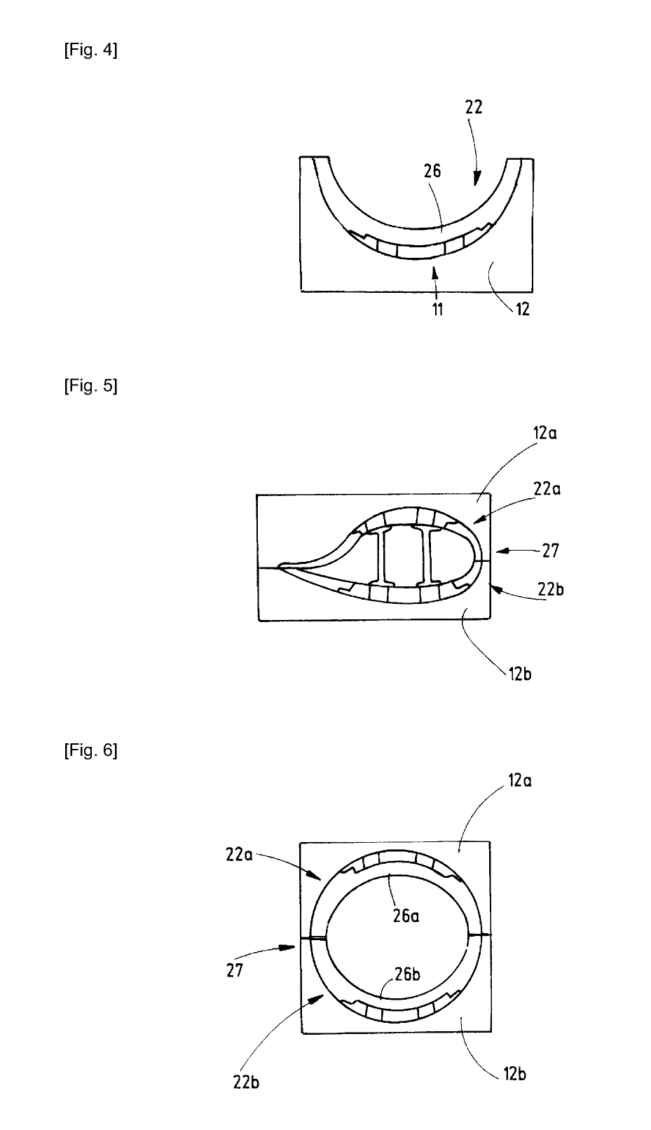

FIG. 4 shows a cross-section of the pre-manufactured first blade member 11 of FIG. 3 in the area of the root portion of the blade half shell to be manufactured in the joining mold 12. On top of the pre-manufactured first blade member 11, another blade member, namely an inner root reinforcement 26, is placed. The inner root reinforcement 26 is bonded to the pre-manufactured first blade member 11 using a vacuum assisted infusion process to form the root portion of the entire blade half shell 22.

In FIG. 5 a cross sectional view of two corresponding blade half shells is shown, namely one blade half shell of the pressure side 22a and one blade half shell of the suction side 22b of the blade. These blade half shells 22a, 22b are located in joining molds 12a, 12b, respectively, said molds 12a, 12b being joined for the bonding process. The half shells 22a, 22b are bonded by means of bonding paste so that an entire blade 27 is in the area of its middle portion is produced.

FIG. 6 shows a cross sectional view of the two corresponding blade half shells 22a, 22b of FIG. 5 in the area of the root portion of the blade 27. The blade half shells 22a, 22b are also bonded by means of bonding paste so that an entire blade 27 in the area of its root portion is manufactured.

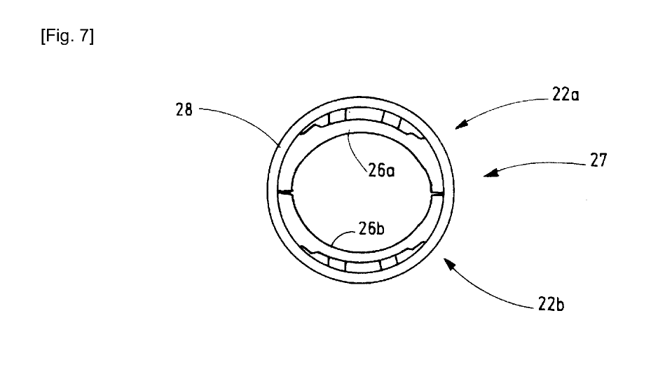

In FIG. 7, the entire blade 27 of FIG. 6 in the area of its root portion is shown. Outer root layers 28 are placed on the outer surface of the root portion of the entire manufactured blade 27 and bonded to the root portion using a vacuum assisted infusion process to form an outer root reinforcement part.

1. A method for manufacturing a wind turbine blade, comprising the steps of:
pre-manufacturing a first blade member,
positioning said pre-manufactured first blade member in a joining mold, and bonding said first blade member with a second blade member using a vacuum assisted infusion process so as to form an integrated blade part.

2. The method according to claim 1, comprising the steps of:
curing the pre-manufactured first blade member,
demolding the pre-manufactured first blade member, and
transporting the pre-manufactured first blade member to the joining mold.

3. The method according to claim 1, comprising the steps of:
curing the integrated blade part,
bonding the integrated blade part with other blade members or other integrated blade parts using a vacuum assisted infusion process, and
repeating the above steps until the entire blade or an entire half shell of the blade is completed.

4. The method according to claim 1,
wherein the first blade member comprises a spar cap, and
wherein the first blade member is positioned in the center of the joining mold.

5. The method according to claim 1,
wherein the first blade member comprises a bonding flange for bonding said first blade member to the second blade member.

6. The method according to claim 5,
wherein the second blade member is made up of blade building material, comprising the steps of:
positioning said blade building material in the joining mold, wherein at least part of the blade building material overlaps the first blade member,
applying a vacuum to the blade building material, and
infusing the blade building material with bonding means.

7. The method according to claim 6,
wherein heat is applied to the integrated blade member for curing the bonding means.

8. The method according to claim 1,
wherein the second blade member is pre-manufactured, comprising the steps of:
positioning said pre-manufactured second blade member next to the first blade member in the joining mold such that an interspace in between them exists,
applying a vacuum to said interspace between the first blade member and the second blade member, and
infusing bonding means into the interspace.

9. The method according to claim 8, comprising the steps of:
curing the pre-manufactured second blade member,
demolding the pre-manufactured second blade member, and
transporting the pre-manufactured second blade member to the joining mold.

10. The method according to claim 8,
wherein a flow medium for the bonding means is placed in the interspace between the first blade member and the second blade member.

11. The method according to claim 8,
wherein heat is applied to the integrated blade member for curing the bonding means.

12. The method according to claim 1,
wherein the blade comprises a middle portion, a tip portion and a root portion, comprising the steps of:
bonding the pre-manufactured first blade member with at least one other blade member using a vacuum assisted infusion process in order to form an integrated part of the middle portion, the tip portion and the root portion of the blade, respectively, and
bonding the integrated part of the middle portion, the integrated part of the tip portion and the integrated part of the root portion to form an entire blade or an entire blade half shell.

13. A method for manufacturing a wind turbine blade,
wherein the blade has a suction side and a pressure side, comprising the steps of:
pre-manufacturing at least one spar cap, at least one shear web, at least one trailing edge part and at least one leading edge part,
bonding said pre-manufactured parts using a vacuum assisted infusion process in a joining mold to form an entire blade or an entire blade half shell of the suction side and the pressure side respectively, and optionally,
bonding the blade half shell of the suction side and the blade half shell of the pressure side to form an entire blade.

14. The method according to claim 13,
wherein multiple trailing edge parts in longitudinal direction and multiple leading edge part in longitudinal direction are pre-manufactured and bonded to each other respectively or to other pre-manufactured parts using a vacuum assisted infusion process.

15. The method according to claim 13,
wherein one or more pre-manufactured parts are bonded with a root reinforcement part in the joining mold using a vacuum assisted infusion process to form a root portion of the entire blade or the entire blade half shell.

16. The method according to claim 15,
wherein outer root layers are placed on the surface of the root portion of the entire blade or entire blade half shell, and
wherein the root portion and the outer root layers are bonded using a vacuum assisted infusion process.

17. A wind turbine blade manufactured by a method comprising the steps of:
pre-manufacturing a first blade member,
positioning said pre-manufactured first blade member in a joining mold,
bonding said first blade member with a second blade member using a vacuum assisted infusion process for forming an integrated part of the blade,
bonding the integrated part with other blade members or integrated blade parts using a vacuum assisted infusion process,
repeating the above steps until an entire blade or an entire half shell of the blade is completed, and optionally
bonding two corresponding blade half shells to form an entire blade.

18. The wind turbine blade according to claim 17,
wherein the pre-manufactured first blade member is placed in the center of the joining mold.
